(19) United States
(12) Patent Application Publication
(10) Pub. No.: US 2023/0313604 A1
(43) Pub. Date: Oct. 5, 2023

(54) CONFIGURABLE BIASING ASSEMBLY FOR FACILITATING RAISING AND LOWERING OF A BLIND ASSEMBLY WITHIN AN INSULATED GLASS UNIT

(71) Applicant: ODL, Incorporated, Zeeland, MI (US)

(72) Inventors: Stacy Frye, Zeeland, MI (US); Rachel DeGraaf, Grand Haven, MI (US); Jeremy Laarman, Zeeland, MI (US); Sharlene Kluchinsky Clark, Holland, MI (US); Brian James Katerberg, Zeeland, MI (US); Gregory Melanson, Telford, PA (US); Seth Vostad, Byron Center, MI (US); Ryan Barclay Neal, Grandville, MI (US)

(21) Appl. No.: 18/190,356

(22) Filed: Mar. 27, 2023

Related U.S. Application Data
(60) Provisional application No. 63/327,105, filed on Apr. 4, 2022.

(51) Int. Cl. E06B 9/322; E06B 9/264; E06B 9/38

(52) U.S. Cl. CPC E06B 9/322; E06B 9/264; E06B 9/38; E06B 3/66309

(57) ABSTRACT

A biasing assembly for facilitating raising and lowering a blind assembly within an insulated glass unit may include a housing configured to be fixed in position within the IG unit, and at least one coil spring carried by the housing, the at least one coil spring having one end coupled to the housing or to a component mounted in the housing and an opposite end configured to operatively couple to a follower assembly for raising and lowering the blind assembly, the at least one coil spring responsive to respective forces applied to the opposite end thereof to pay out of, and be taken up in, the housing.

### CROSS-REFERENCE TO RELATED APPLICATION

This patent application claims the benefit of, and priority to, U.S. Provisional Patent Application Ser. No. 63/327,105, filed Apr. 4, 2022, the disclosure of which is incorporated herein by reference in its entirety.

### TECHNICAL FIELD

The present disclosure relates generally to insulated glass (IG) units including blind assemblies disposed between opposing panels thereof, and further to biasing assemblies, coupleable to blind raising and lowering follower assemblies, for facilitating raising and lowering of such blind assemblies.

### BACKGROUND

Blind assemblies disposed between opposing panels of conventional insulated glass (IG) units are known. Some such assemblies utilize follower assemblies for raising and lowering the blind assemblies and/or to rotate the blind slats between open and closed positions. In some implementations, e.g., in which the blind assemblies have substantial weight, conventional weighted and/or capture mechanisms may be implemented to reduce the forces required to operate the blind assemblies and/or to maintain the blind assemblies in raised or lowered positions.

### SUMMARY

The present disclosure may comprise one or more of the features recited in the attached claims, and/or one or more of the following features and combinations thereof. In a first aspect, a biasing assembly for facilitating raising and lowering a blind assembly within an insulated glass unit may comprise a housing configured to be fixed in position within the IG unit, and at least one coil spring carried by the housing, the at least one coil spring having one end coupled to the housing or to a component mounted in the housing and an opposite end configured to operatively couple to a follower assembly for raising and lowering the blind assembly, the at least one coil spring responsive to respective forces applied to the opposite end thereof to pay out of, and be taken up in, the housing.

A second aspect may include the features of the first aspect, and wherein the housing may define a pocket having at least one spring carrier defined therein, and wherein the at least one coil spring may be operatively mounted to at least one spring carrier within the pocket of the housing.

A third aspect may include the features of either of the first and second aspects, and wherein the at least one coil spring may comprise at least one coiled flat spring.

A fourth aspect may include the features of either of the second and third aspects, wherein the at least one spring carrier may comprise a number of spokes arranged in a concentric pattern, and wherein the at least one coiled flat spring may be mounted on and about the number of spokes of the at least one spring carrier with the one end of the at least one coiled flat spring coupled to at least one of the number of spokes.

A fifth aspect may include the features of any of the first through fourth aspects, wherein the at least one coil spring may comprise at least one negative coil spring configured to impart a negative spring bias between the IG unit and the follower assembly.

A sixth aspect may include the features of any of the first through fifth aspects, wherein the at least one coil spring may comprise two or more negative coil springs each having one end coupled to the housing or to a component mounted in the housing and an opposite end configured to operatively couple to the follower assembly.

A seventh aspect may include the features of either of the fifth and sixth aspects, wherein the at least one coil spring further comprises at least one of (a) one or more positive coil springs having one end coupled to the housing or to a component mounted in the housing and an opposite end configured to operatively couple to the follower assembly, the one or more positive coil springs configured to impart a positive spring bias between the IG unit and the follower assembly, and (b) one or more constant-bias coil springs having one end coupled to the housing or to a component mounted in the housing and an opposite end configured to operatively couple to the follower assembly, the one or more constant-bias coil springs configured to impart a constant spring bias between the IG unit and the follower assembly.

In an eighth aspect, a blind control assembly, for controlling raising and lowering of a blind assembly within an insulated glass (IG) unit, may comprise a follower assembly configured to be movable along a channel defined in the IG unit, the follower assembly configured to be coupled via a cord to the blind assembly such that movement of the follower assembly along the channel causes the cord to raise and lower the blind assembly within the IG unit, and a biasing assembly configured to be fixed in position within the channel defined in the IG unit, the biasing assembly including at least one coil spring having a first end coupled to the biasing assembly and a second end coupled to the follower assembly, wherein the at least one coil spring is paid out of the biasing assembly by movement of the follower assembly away from the biasing assembly and is taken up in the biasing assembly by movement of the follower assembly toward the biasing assembly.

A ninth aspect may include the features of the eighth aspect, wherein the biasing assembly may comprise a first housing configured to be fixed in position within the channel of the IG unit, wherein the first housing defines a pocket having at least one spring carrier defined therein, and wherein the at least one coil spring is operatively mounted to at least one spring carrier within the pocket of the first housing and the first end of the at least one coil spring is coupled to the at least one spring carrier.

A tenth aspect, may include the features of either of the eighth and ninth aspects, wherein the at least one coil spring comprises at least one coiled flat spring.

An eleventh aspect may include the features of any of the eighth through tenth aspects, wherein the at least one coil spring may comprise at least one of (a) one or more negative coil springs configured to impart a negative spring bias between the biasing assembly and the follower assembly, (b) one or more positive coil springs having one end coupled to the housing or to a component mounted in the housing and an opposite end configured to operatively couple to the follower assembly, the one or more positive coil springs configured to impart a positive spring bias between the biasing assembly and the follower assembly, and (c) one or more constant-bias coil springs having one end coupled to the housing or to a component mounted in the housing and an opposite end configured to operatively couple to the follower assembly, the one or more constant-bias coil springs configured to impart a constant spring bias between the biasing assembly and the follower assembly.

A twelfth aspect may include the features of any of the ninth through eleventh aspects, wherein the follower assembly may comprise a second housing movable along the channel of the IG unit, and wherein the second end of the at least one coil spring and the second housing may be configured to be coupled to one another.

A thirteenth aspect may include the features of the twelfth aspect, wherein the second end of the at least one coil spring may comprise a head spaced part from a main body of the at least one coil spring and a neck defined between the head and the main body, the neck having a width less than widths of the head and the main body, and wherein the second housing may define a second pocket and a second slot through the second housing and into the second pocket, the second slot configured to receive the head of the at least one coil spring therethrough and the second pocket configured to receive the head of the at least one coil spring therein via the second slot and to retain the head therein to couple the second end of the at least one coil spring to the second housing.

A fourteenth aspect may include the features of the thirteenth aspect, wherein the at least one coil spring may comprise a plurality of coil springs each having a head spaced part from a main body of the coil spring and a neck positioned between the head and the main body with the neck having a width less than widths of the head and main body, and wherein the second slot may be configured to receive the heads of each of the plurality of coil springs therethrough and the second pocket is configured to receive the heads of each of the plurality of coil springs therein via the second slot and to retain the heads of each of the plurality of coil springs therein to couple the second ends of the plurality of coil springs to the second housing.

A fifteenth aspect may include the features of any of the twelfth through fourteenth aspects, wherein the blind control assembly may further comprise one of a magnet and a ferromagnetic component coupled to the first housing, and the other of a magnet and a ferromagnetic component coupled to the second housing, wherein the magnet and the ferromagnetic component are positioned on a respective one of the first and second housings to magnetically couple to one another upon movement of the follower assembly proximate to the biasing assembly.

In a sixteenth aspect, an insulated glass unit may comprise first and second spaced apart panels, a spacer affixed to inner surfaces of each of the first and second panels about a periphery of the first and second panels to define an air space bounded by the spacer and the first and second panels, a blind assembly, including a plurality of blind slats, disposed within the air space, a flexible cord operatively coupled to the blind assembly for raising and lowering the plurality of blind slats, a follower assembly coupled via the cord to the blind assembly, the follower assembly movable along a channel defined in the airspace of the IG assembly to raise and lower the blind assembly, and a biasing assembly fixed in position within the channel, the biasing assembly including at least one coil spring having a first end coupled to the biasing assembly and a second end coupled to the follower assembly, wherein the at least one coiled spring is paid out of the biasing assembly by movement of the follower assembly along the channel away from the biasing assembly and is taken up in the biasing assembly by movement of the follower assembly along the channel toward the biasing assembly.

A seventeenth aspect may include the features of the sixteenth aspect, wherein the at least one coil spring may comprise at least one coiled flat spring.

An eighteenth aspect may include the features of either of the sixteenth and the seventeenth aspects, wherein the at least one coil spring may comprise at least one of (a) one or more negative coil springs configured to impart a negative spring bias between the biasing assembly and the follower assembly, (b) one or more positive coil springs having one end coupled to the housing or to a component mounted in the housing and an opposite end configured to operatively couple to the follower assembly, the one or more positive coil springs configured to impart a positive spring bias between the biasing assembly and the follower assembly, and (c) one or more constant-bias coil springs having one end coupled to the housing or to a component mounted in the housing and an opposite end configured to operatively couple to the follower assembly, the one or more constant-bias coil springs configured to impart a constant spring bias between the biasing assembly and the follower assembly.

A nineteenth aspect may include the features of any of the sixteenth through eighteenth aspects, wherein the biasing assembly may comprise a first housing configured to be fixed in position within the channel, wherein the follower assembly may comprise a second housing, and wherein the at least one coil spring may be operatively mounted to the first housing, the first end of the at least one coil spring is coupled to the first housing or to a component mounted to the first housing and the second end of the at least one coil spring is coupled to the second housing.

A twentieth aspect may include the features of the nineteenth aspect, and may further include one of a magnet and a ferromagnetic component coupled to the first housing, and the other of a magnet and a ferromagnetic component coupled to the second housing, wherein the magnet and the ferromagnetic component are positioned on a respective one of the first and second housings to magnetically couple to one another upon movement of the follower assembly proximate to the biasing assembly.

### BRIEF DESCRIPTION OF THE DRAWINGS

FIG. 1A is an assembly view of an embodiment of a panel assembly including a blind assembly, in a fully raised position, disposed between opposed panels of the panel assembly, and including an embodiment of a follower assembly and a configurable biasing assembly, operatively coupled to the follower assembly, for facilitating raising and lowering of the blind assembly.

FIG. 1B is an assembly view of the panel assembly of FIG. 1A with the blind assembly shown in a fully lowered position.

FIG. 2 is a front perspective and assembled view of the panel assembly depicted in FIGS. 1A and 1B shown with the blind assembly in the fully raised position.

FIG. 3 is a partial cutaway view of the portion M of the panel assembly of FIG. 2 illustrating the follower assembly and the configurable biasing assembly operatively coupled thereto, and illustrating operation of the follower assembly using a conventional operator assembly.

FIG. 4A is a left, front perspective view of the follower assembly and configurable biasing assembly of FIG. 3 illustrating an embodiment of a structural configuration for operatively coupling one or more biasing members of the configurable biasing assembly to the follower assembly.

FIG. 4B is a left, front perspective view similar to FIG. 4A and illustrating coupling of the one or more biasing members of the configurable biasing assembly to the follower assembly.

FIG. 4C is a left, front perspective view similar to FIG. 4B and illustrating decoupling of the follower assembly, under bias of the configurable biasing assembly, as the follower assembly is moved upwardly relative to the panel assembly to lower the blind assembly as depicted by example in FIG. 1B.

FIG. 5 is a left, front perspective view similar to FIG. 4A illustrating an alternate embodiment of the configurable biasing assembly which includes two of the biasing members operatively coupleable to the follower assembly.

FIG. 6 is a left, front perspective view similar to FIGS. 4A and 5 illustrating another alternate embodiment of the configurable biasing assembly which includes a single one of the biasing members operatively coupleable to the follower assembly.

FIG. 7A is a front elevational view of an embodiment of a portion of the tilt assembly and of the follower assembly each configured to releasably couple to one another.

FIG. 7B is a front elevational view similar to FIG. 7A and showing the follower assembly and the tilt assembly coupled to one another.

### DESCRIPTION OF THE ILLUSTRATIVE EMBODIMENTS

For the purposes of promoting an understanding of the principles of this disclosure, reference will now be made to a number of illustrative embodiments shown in the attached drawings and specific language will be used to describe the same.

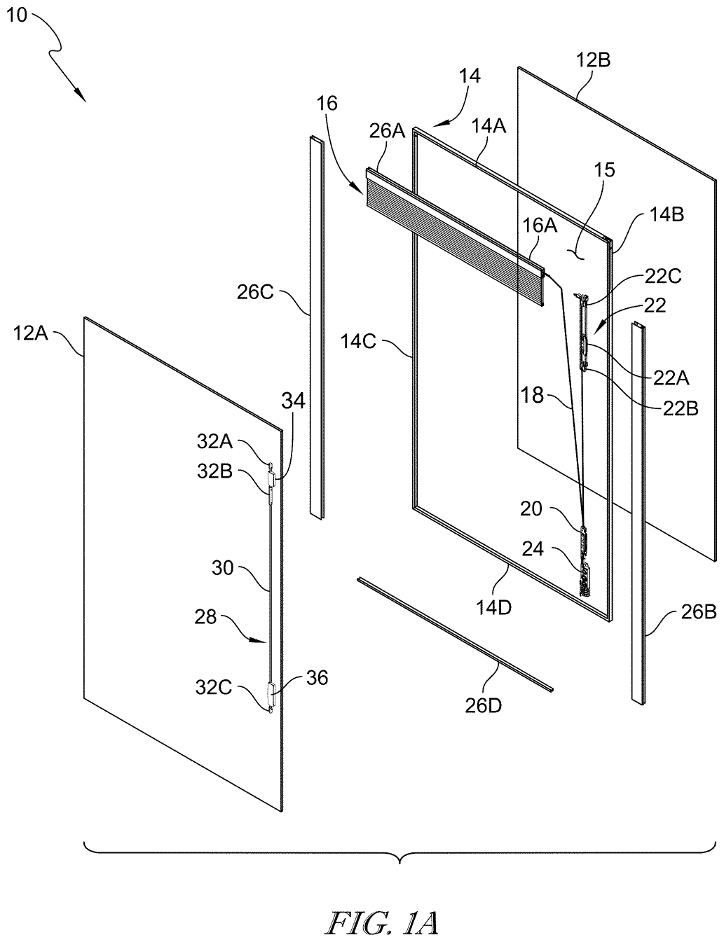

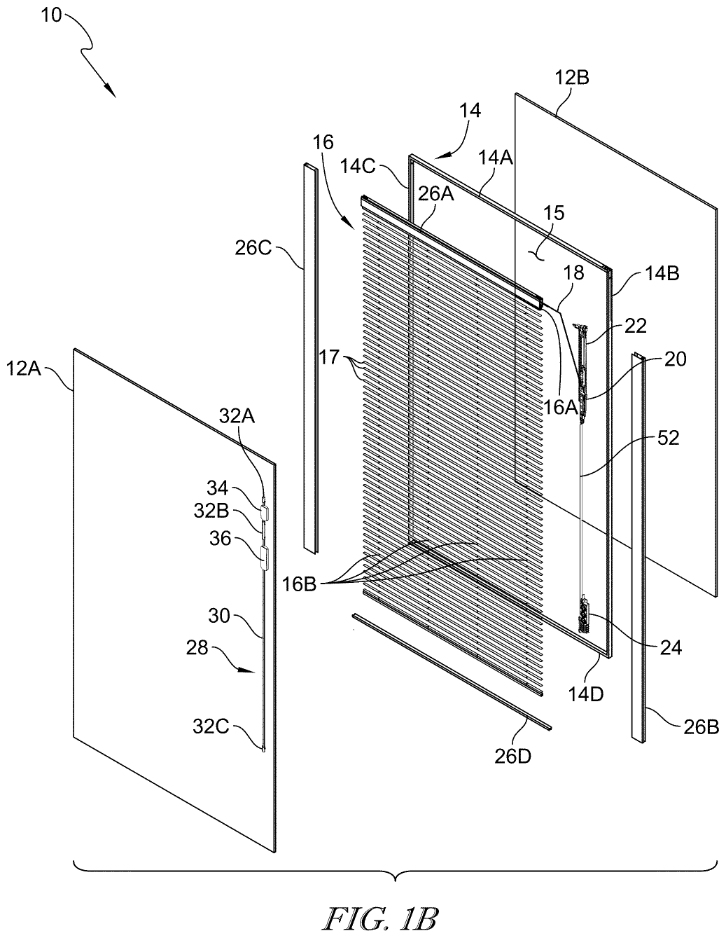

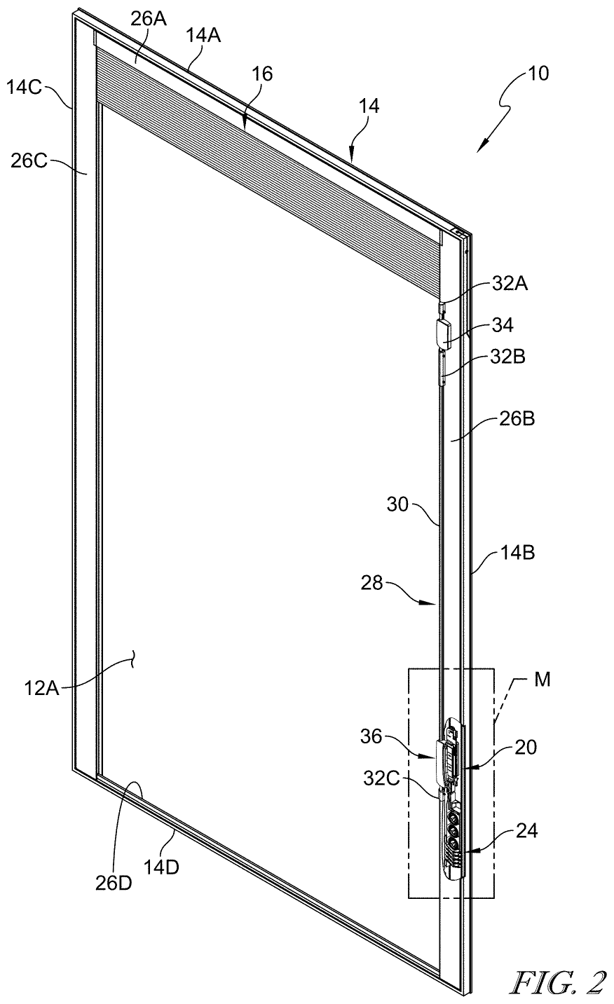

This disclosure relates generally to insulated glass (IG) units having a blind assembly mounted between opposed panels thereof, and more particularly to such units in which a biasing assembly is operatively mounted to the blind assembly for facilitating raising and lowering of the blind assembly, and even more particularly to such units in which an actuatable follower assembly is operatively mounted to the blind assembly for raising and lowering the blind assembly and the biasing assembly is operatively coupled to the follower assembly. Referring now to FIGS. 1A-2, an embodiment is shown of a panel assembly 10 in which an embodiment of a follower assembly 20, and of a configurable biasing assembly 24 operatively coupled to the follower assembly 20, is shown. In the illustrated embodiment, the panel assembly 10 includes a pair of opposed panels 12A, 12B each having inner planar surfaces to which a conventional spacer 14 is attached about the periphery of each panel 12A, 12B in a conventional manner. Illustratively, the spacer 14 is positioned between and adhered to the inner surfaces of each of the panels 12A, 12B, and extends along and adjacent to the opposed top and bottom edges of the panels 12A, 12B as well as along and adjacent to the opposed side edges of the panels 12A, 12B as is conventional. An airspace 15 is defined between the panels 12A, 12B and bounded by the spacer 14.

In some embodiments, each panel 12A, 12B is illustratively made of glass, and in such embodiments the panels 12A, 12B and the spacer 14 to which the panels 12A, 12B are affixed are together sometimes referred to as a so-called “insulated glass” or IG unit. In some alternate embodiments, either of both of the panels 12A, 12B may be or include one or more alternate materials, examples of which include, but are not limited to, optically transparent or translucent polycarbonate, poly(methyl methacrylate), also known as PMMA or acrylic, or the like. In any such embodiment, either or both of the panels 12A, 12B may be or include multiple materials and/or may be or include one or more areas of transparency, one or more areas of translucence, one or more areas of opaqueness and/or one or more non light-transmissive areas. Each panel 12A, 12B is further illustrated in FIGS. 1A and 1B as including a single panel, although it will be understood that in alternate embodiments either or both of the panels 12A, 12B, may be or include two or more juxtaposed panels defining an air space therebetween and/or joined by one or more films, adhesives or the like. In some such alternative embodiments, two more spacers 14 may be used to separate the multiple panels, wherein each set of opposed panels is adhered to a respective spacer 14. In some embodiments, either or both of the panels 12A, 12B may have one or more coatings or films applied to either or both of the inner and outer planar surfaces thereof. Alternatively or additionally, one or more films and/or other structures may be positioned between the juxtaposed panels 12A, 12B. The IG unit 12 may illustratively have any length and/or width, and/or have any geometrical configuration, and may be implemented as, or as part of, an openable window, a non-opening window, a door, a skylight or the like.

In the illustrated embodiment, elongated fasciae 26A-26D are provided, and each fascia 26A-26D is coupled, in a conventional manner, to an along an inner portion of a respective elongated member of the spacer 14 such that the fasciae 26A-26D are disposed within the airspace 15 bounded by the spacer 14. For example, a top fascia 26A is coupled to a top, e.g., horizontally-disposed, member 14A of the spacer 14, side fasciae 26B, 26C are coupled to respective side, e.g., vertically-disposed, members 14B, 14C, and a bottom fascia 26D is coupled to a bottom, e.g., horizontally-disposed, member 14D of the spacer 14. In the illustrated embodiment, the spacer 14 and the fasciae 26A-26D are configured such that outer edges of the fasciae 26A-26D snap into and between inner flanges of the spacer 14. In alternate embodiments, one or more of the fasciae 26A-26D may be coupled to a respective member of the spacer 14 using any conventional fastening structure(s) and/or any conventional bonding medium(s).

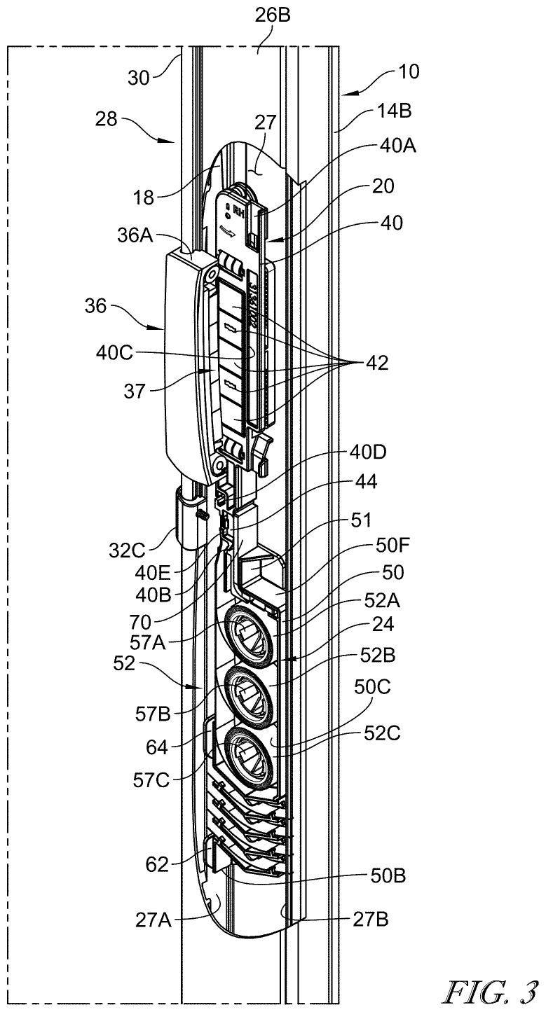

A blind assembly 16 is disposed within an airspace 15 defined between the panels 12A, 12B and the spacer, and the blind assembly 16 is illustratively mounted to the top member 14A of the spacer 14. In the illustrated embodiment, for example, the blind assembly 16 includes a conventional mounting assembly 16A including one or more conventional retaining members operatively coupled in a conventional manner to the top fascia 26A which is, as described above, mounted to the top, horizontally-disposed member 14A of the spacer 14. The blind assembly 16 further includes a plurality of slats 17 operatively coupled to the mounting assembly 16A via a plurality of conventional slat operating cords 16B, a flexible blind actuating cord 18 operatively coupled to the mounting assembly 16A, the follower assembly 20 having a top portion through which the cord 18 passes and a tilt assembly 22 also coupled to the cord 18. As depicted by example in FIG. 1A, the tilt assembly 22 illustratively includes a tilt module 22A movably coupled to and between an intermediate pulley base 22B and an upper pulley base 22C. The biasing assembly 24 is operatively coupled to a bottom portion of the follower assembly 20 as illustrated by example in FIGS. 1A, 1B and 2. The mounting assembly 16A, the plurality of slats 17, the slat operating cords 16B, the blind actuating cord 18, the follower assembly 20, the tilt assembly 22 and the biasing assembly 24 are all disposed within the airspace 15 defined between the panels 12A, 12B and the bounded by the spacer 14. A portion or portions of the flexible actuating cord 18 of the blind assembly 16 is/are operatively coupled to the mounting assembly 16A in a conventional manner, and a remaining portion of the cord 18 extends into an elongated channel 27 defined by and within the side fascia 26B as depicted by example in FIG. 3. The mounting assembly 16A illustratively includes conventional components (not shown) responsive to actuation of the cord 18 to raise and lower the plurality of slats 17 and to adjust a tilt angle of the plurality of slats 17 between a fully open, e.g., substantially horizontal, position and either of two fully closed positions, e.g., rotated approximately 75 degrees forwardly from horizontal or rotated approximately 75 rearwardly from horizontal, as is conventional. The cord 18, follower assembly 20 and biasing assembly 24 may together be referred to herein as a blind control assembly.

The cord 18, follower assembly 20 and tilt module 22B are all movable along and within the channel 27 defined within the side fascia 26B in a conventional manner, whereas the intermediate pulley base 22B and the upper pulley base 22C are fixed in position within the channel 27 such that the tilt module 22B is movable between and relative to, the pulley bases 22B, 22C in a conventional manner. The biasing assembly 24 is illustratively fixed in position within the channel 27 at, adjacent to or spaced part from the bottom fascia 26D. As will be described in greater detail below, the biasing assembly 24 is illustratively configured to magnetically engage and couple to the follower assembly 20 under certain operating conditions of the blind assembly 16, e.g., when the blind assembly 16 is fully raised as illustrated by example in FIGS. 1A and 3, and is configured to bias the follower assembly 20 relative thereto under bias of one or more biasing members 52, e.g., as the follower assembly 20 is drawn upwardly to lower the blind assembly 16 as illustrated by example in FIG. 1B.

In the embodiment illustrated in FIGS. 1A-2, an elongated track assembly 28 is mounted to an outer surface of the panel 12A such that the track assembly 28 is positioned over, and through, a portion of the side fascia 26B. The track assembly 28 illustratively includes an elongated track 30 secured to the outer surface of the panel 12A via coupling members 32A, 32B and 32C mechanically fastened to the track 30 and to the outer surface of the panel 12A. A tilt operator assembly 34 is configured to engage the track 30 between the coupling members 32A and 32B, and a raise/lower operator assembly 36 is configured to engage the track 30 between the coupling members 32B and 32C. Both of the operator assemblies 34, 36 are configured to move relative to and along the track 30. The coupling members 32A, 32B, 32C are configured to act as stops to the travel of the operator assemblies 34, 36 such that the tilt operator assembly 34 is movable along and relative to the track 30 between the coupling members 32A and 32B and the raise/lower operator assembly 36 is movable along and relative to the track 30 between the coupling members 32B, 32C. The operator assemblies 34, 36 are both conventional in construction and operation, and in the illustrated embodiment the operator assemblies 34, 26, the tilt module 22A and the follower assembly 20 each include one or more conventional magnets for magnetically coupling the operator assembly 34 to the tilt assembly 22 and for magnetically coupling the operator assembly 36 to the follower assembly 20.

By manual movement of the tilt operator assembly 34 along the track 30 between the coupling members 32A, 32B, the tilt module 22A magnetically coupled thereto is moved in like manner along the channel 27 between the pulley bases 22B, 22C to adjust in a conventional manner the tilt angle of the plurality of blind slats 17. Similarly, by manual movement of the raise/lower operator assembly 36 along the track 30 between the coupling members 32B, 32C, the follower assembly 20 magnetically coupled thereto is moved in like manner along the channel 27 to effect in a conventional manner, e.g., via corresponding movement of the cord 18 and resulting actuation of conventional components carried by the mounting assembly 16A of the blind assembly 16, raising and lowering of the plurality of blind slats 17 within the airspace 15 defined between the panels 12A, 12B. In the fully raised or near-fully raised position of the blind assembly 16 illustrated by example in FIG. 1A, the follower assembly 20 is illustratively configured such that one or more magnets mounted to a lower portion of the follower assembly 20 magnetically engage(s) the biasing assembly 24 (as will be described in greater detail with respect to FIGS. 3-6) in order to prevent the follower assembly 20, and thus the bottom end of the plurality of slats 16B, from moving downwardly in the absence of intended, manual movement of the raise/lower operator assembly 36 (also known as downward blind creep).

Referring now to FIGS. 3-6, an embodiment is shown of the follower assembly 20 depicted be example in FIGS. 1A-2 and briefly described above. In the embodiment illustrated in FIGS. 3-6, the follower assembly 20 illustratively includes an elongated follower housing 40 configured to receive a plurality of magnets 42. In the illustrated embodiment, the elongated follower housing 40 is generally rectangular in shape having long sides disposed generally vertically between a top 40A of the housing 40 and a bottom 40B of the housing 40, and short sides disposed generally horizontally at and between the top and bottom 40A, 40B of the housing 40. The housing 40 illustratively defines a pocket 40C open to a front surface of the housing and extending to a rear or back surface of the housing 40. The pocket 40C is illustratively rectangular in shape having vertically disposed, opposing long or longitudinal sides generally parallel with the long sides of the housing 40 and having horizontally disposed opposing short or transverse sides generally parallel with the short sides of the housing 40. The magnets 42, e.g., five such magnets 42 in the illustrated embodiment, are disposed in the pocket 40C of the housing 40, and are sized complementary to the pocket 40C such that the magnets 42 are arranged side-by-side within the pocket 40C such that the exposed faces of the magnets 42 are flush or slightly proud with respect the front surface of the housing 40. While five magnets 42 are included in the embodiment of the follower assembly 20 illustrated in FIGS. 3-6, alternate embodiments may include more or fewer magnets with the resulting collection of magnets together (or singly) sized to substantially fill the pocket 40C of the housing 40.

Referring now specifically to FIG. 3, a magnified and partial cutaway view is shown of the portion M of the panel assembly 10 illustrated in FIG. 2. The raise/lower operator assembly 36 illustratively includes a housing 36A configured to slidingly engage the track 30 such that the housing 36A is slidable upwardly and downwardly along the track 30 in a conventional manner. One or more magnets 37 is/are mounted to and carried by the housing 36A and generally face the magnet(s) 42 carried by the follower housing 40 of the follower assembly 20. The housing 36A is generally positioned such that the magnet(s) 37 is/are juxtaposed with the magnet(s) 42 so as to magnetically engage the operator assembly 36 with the follower assembly 20 through the panel 12A and side fascia 26B as shown and as is conventional. As the raise/lower operator assembly 36 is moved upwardly and downwardly along the track 30, the follower assembly 20 is correspondingly moved along the channel 27 via the magnetic engagement between the magnet(s) 37 carried by the operator assembly housing 36A and the magnet(s) 42 carried by the follower housing 40. As the follower assembly 20 moves upwardly and downwardly along the channel 27, the cord 18 passing through the follower assembly 20 at or near the top 40A of the housing 40 is operatively coupled to conventional components to raise and lower the blind slats 17 also in a conventional manner.

With respect to the aspects and features of the follower assembly 20 that relate to operative engagement with the cord 18 and with the operator assembly 36 as described herein, further details of the structure and operation of an embodiment of the follower assembly 20 are described in co-pending U.S. patent application Ser. No. 17/495,878, filed Oct. 7, 2021 and now published as U.S. Patent Application Pub. No. US 2022/0112763A1, the disclosure of which is incorporated by reference in its entirety. It will be understood, however, that with respect to the aspects and features of the follower assembly 20 that relate to operative engagement with, and operation relative to, the cord 18 and the operator assembly 36 as described herein, the embodiment of the follower assembly 20 illustrated in FIGS. 3-6 represents only one non-limiting example of the follower assembly 20, and that alternate embodiments of the follower assembly 20 (with respect to such aspects and features) are contemplated by this disclosure. Details of one embodiment of the aspects and features of the follower assembly 20 and/or any variants or alternate embodiment thereof that relate to operative engagement with, and operation relative to, the biasing assembly 24 will be described in detail below.

Referring now to FIGS. 3-6, details of an embodiment of the biasing assembly 24, and of an embodiment of a configuration of the lower portion 40B of the housing 40 of the follower assembly 20 for operatively coupling to the biasing assembly 24, will now be described. In the illustrated embodiment, the biasing assembly 24 includes an elongated housing 50 having a top end 50A, a bottom end 50B opposite the top end 50A and a pocket 50C defined between the top and bottom ends 50A, 50B respectively. The pocket 50C is illustratively configured to carry, and operatively couple to, one or more biasing members 52. In the illustrated embodiment, the pocket 50C is configured to carry, and operatively couple to, up to three biasing members 52A-52C, although in alternate embodiments the pocket 50C may be configured to carry, and operatively couple to, more or fewer biasing members 52.

The lower portion of the housing 50 of the biasing assembly 24 is configured to be secured within the channel 27 to at least one side of the fascia 26B so as to fix the biasing assembly 24 in a static position within the channel 27 relative to the fascia 26B. In some embodiments, the lower portion 50 of the biasing assembly 24 is configured to be secured to and between the opposed surfaces 27A, 27B of the fascia 26B. In the illustrated embodiment, for example, the lower portion of the biasing assembly 24 includes a number of laterally extending fins 66 oriented and configured to engage the opposed, vertically-extending surfaces 27A, 27B of the fascia 26B in a manner which allows the biasing assembly 24 to travel along the channel 27 in a downwardly direction, but which prevents the biasing assembly 24 from traveling upwardly along the channel 27, as illustrated by example in FIG. 3. In this embodiment, the biasing assembly 24 is fixed within the channel 27 by inserting the biasing assembly 24 into the channel 27 and forcing the biasing assembly 24 downwardly along the channel 27 to a suitable position relative to the bottom of the channel 27, i.e., relative to the junction of the side fascia 26B with the bottom fascia 26D. It will be understood that the illustrated fin structure 66 is provided only by way of example, and that that this disclosure contemplates other conventional structures and/or techniques for locating and fixing the position of the biasing assembly 24 within and relative to the channel 27.

The fixed position of the biasing assembly 24 within the channel 27 and relative to the bottom of the channel 27 may vary by application, although the biasing assembly 24 will generally be positioned within the channel 27, and relative to the bottom of the channel 27, such that the bottom portion of the follower assembly 20 couples to the top portion of the biasing assembly 24 (as will be described in detail below) when the blind assembly 16 is in a fully raised position as depicted by example in FIG. 1A. A locating member 62 is defined along one side of the housing 50 below the fins 66, and another locating member 64 is defines along the same side of the housing 50 above the fins 66. The locating members 62, 64 are illustratively configured, e.g., with planar surfaces, to engage the planar surface 27A of the inner side of the side fascia 26B (the inner side 27A of the side fascia 26B being the vertically-extending side of the fascia 26B that is furthest away from the spacer side 14B) as the biasing assembly 24 is inserted into the channel 27 and act to locate the biasing assembly 24 laterally or transversely within the channel 27 so as to align the biasing assembly 24 with the follower assembly 20 within the channel 27 to ensure coupling therebetween in the lowermost position of the follower assembly 20 within the channel 27. In alternate embodiments, the locating member 62 and/or the locating member 64 may be non-planar and/or defined on the opposite side of the housing 50 so as to face and engage the outer side 27B of the side fascia 26B (the outer side 27B of the side fascia 26B being the vertically-extending side of the fascia 26B that is closed to, i.e., adjacent to, the spacer side 14B) as the biasing assembly 24 is inserted into the channel 27.

As briefly described above, the biasing assembly 24 and follower assembly 40 are each configured to couple to one another as the follower assembly 40 is lowered within the channel 27 toward, and eventually to, the biasing assembly 24 as the blind assembly 16 is raised to its fully raised position as depicted by example in FIG. 1A. Such coupling of the follower assembly 20 to the biasing assembly 24 illustratively prevents the follower assembly 20, and thus the bottom end of the plurality of slats 17, from moving downwardly in the absence of intended, manual movement of the raise/lower operator assembly 36 (also known as downward blind creep). In one embodiment, such coupling of the follower assembly 20 and the biasing assembly 24 is accomplished via magnetic coupling. In some such embodiments, the bottom portion of the housing 40 of the follower assembly 20 or the top portion of the housing 50 of the biasing assembly 24 carries at least one magnet and the other carries at least one ferromagnetic or paramagnetic material. In other embodiments, the bottom portion of the housing 40 of the follower assembly 20 and the top portion of the housing 50 of the biasing assembly 24 may each carry one or more magnets configured to magnetically couple to one another. In any case, the magnetic attraction force between the bottom portion of the housing 40 of the follower assembly 20 and the top portion of the housing 50 of the biasing assembly 24 will be configured to be less than that of the attractive force between the magnet(s) 42 of the follower assembly 20 and the magnet(s) 37 carried by the raise/lower operator assembly 36, such that the lower portion of the housing 40 of the follower assembly 20 will magnetically disengage from the top portion of the housing 50 of the biasing assembly via upward manual force applied to the raise/lower operator assembly 36 so as to allow the raise/lower operator assembly 36 along the track 30 to raise the blind slats 17 as described above. In alternate embodiments, the lower portion of the housing 40 of the follower assembly 20 and the upper or top portion of the housing 50 of the biasing assembly 24 may be configured, or fitted with suitable conventional structures, for accomplishing such coupling between the housing 40, 50 in a non-magnetic manner, e.g., via one or more conventional mechanical coupling mechanisms, which non-magnetic coupling may be decoupled or disengaged via the raise/lower operator assembly 36 as just described.

As briefly described above, coupling between the housings 40, 50 of the follower assembly 20 and the biasing assembly 24 respectively is illustratively accomplished magnetically. In the illustrated embodiment, for example, the lower portion of the housing 40 carries a permanent magnet 44, and the upper portion of the housing 50 carries a ferromagnetic strip or plate 70, wherein the magnet 44 and the ferromagnetic strip or plate 70 are positioned to magnetically engage, i.e., magnetically couple to, one another as the bottom end 40B of the housing 40 of the follower assembly 20 is drawn toward the top end 50A of the housing 50 of the biasing assembly 24. In alternate embodiments, the housing 50 may be configured to carry the magnet and the housing 40 may be configured to carry the ferromagnetic strip or plate, or the housings 40, 50 may each be fitted with permanent magnets positioned and arranged to magnetically attract and couple to one another.

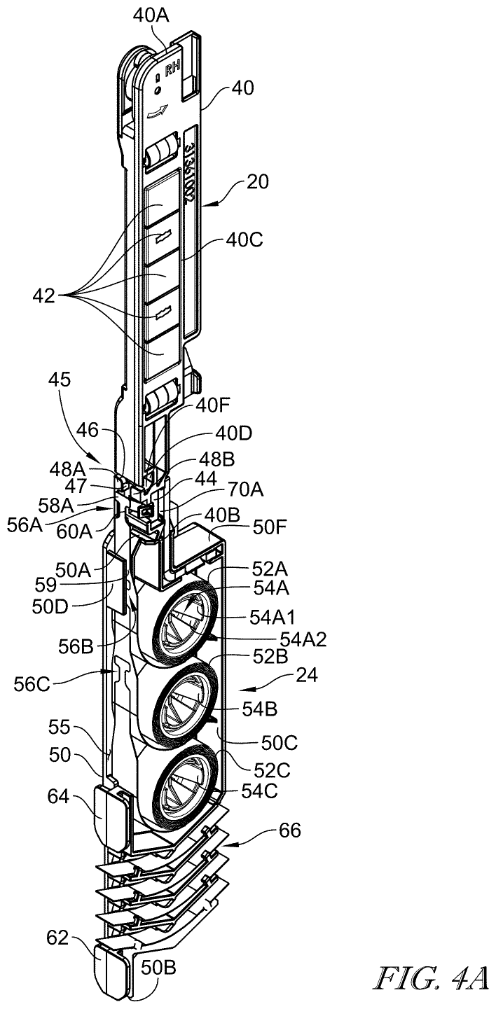

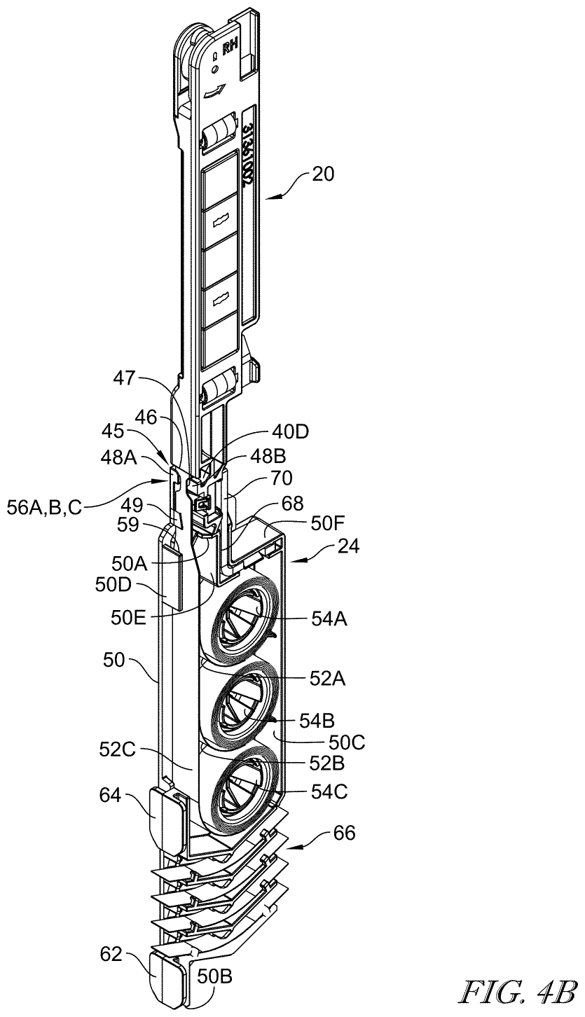

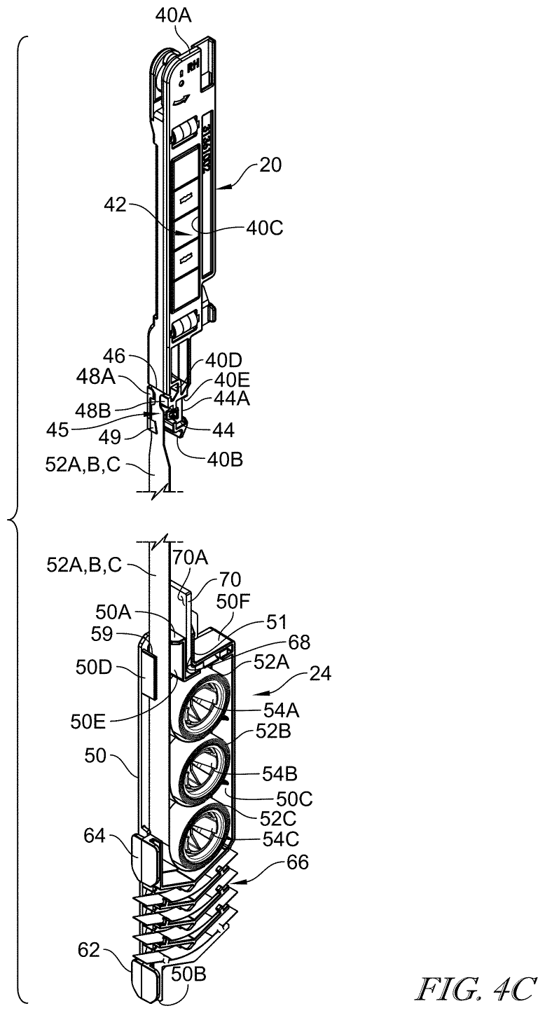

As best seen in FIGS. 3, 4A and 4C, the bottom portion of the housing 40 illustratively defines a pocket or channel 40E which resides just above the bottom end 40B of the housing 40 and has an open end which faces the inwardly-facing side 27B of the fascia 26B when the follower assembly 20 is received within the channel 27. The magnet 44 is received and retained in the pocket or channel 40E with one face 44A of the magnet 44 also facing the inwardly-facing side 27B of the fascia 26B (see, e.g., FIGS. 3 and 4C). The top portion of the housing 50, in turn, illustratively defines a vertically-extending channel 68 between a side wall 51 extending upwardly from an upper transverse wall 50F of the housing 50 and another side wall 50E spaced apart from, and generally parallel with, the side wall 51. A top end of the side wall 50E defines the top end 50A of the housing 50, and in the illustrated embodiment the top end 50A of the housing 50 is a transverse wall which tops the side wall 50E. In any case, the channel 68 is illustratively sized to receive and retain the ferromagnetic strip or plate 70 therein such that magnet-engaging face 70A of the strip or plate 70 faces toward the inner surface 27A of the side fascia when the biasing assembly 24 is positioned within the channel 27. The channels 40E and 68, as well as the magnet 44 and ferromagnetic strip or plate 70, are all configured such that the face 44A of the magnet and the face 70A of the ferromagnetic strip or plate 70 either contact one another, or are at least within a magnetically attractable distance from one another, as the bottom end 40B of the housing is drawn vertically downwardly in an along the channel 27 toward and into contact with a top end 50A of the housing 50 of the biasing assembly 24 such that the magnet 44 and the ferromagnetic strip or plate 70 magnetically couple to one other as best see in FIGS. 3, 4A and 4B.

In the embodiment illustrated in FIGS. 2-6, the biasing members 52A-52C are illustratively provided in the form of coiled flat springs each having one end 56A, 56B, 56C configured to engage and couple to a lower portion of the housing 40 of the follower assembly 40 and an opposite end 57A, 57B, 57C configured to engage and couple to the housing 50 of the biasing assembly 24. The pocket 50C of the housing 50 of the biasing assembly 24 illustratively includes three vertically spaced-apart carriers 54A-54C each configured with a generally cylindrical shape and sized to receive a respective one of the coiled flat springs 52A-52C thereon. As best shown in FIG. 4A, the carrier 54A illustratively includes a number of spokes 54A1 each extending away from an inwardly-facing surface of a rear wall 55 of the housing in a concentric pattern, wherein the spokes 54A1 are separated from one another by slots 54A2. In one embodiment, the spokes 54A1 and the housing 50 are of unitary construction, although in alternate embodiments the spokes 54A1 may be separate from, and attachable to, the housing 50. In any case, the carriers 54B and 54C are illustratively configured identically to the carrier 54A. As best shown in FIG. 3, the coiled flat springs 52A-52C are coupled to the carriers 54A-54C respectively with the ends 57A, 57B, 57C of the coiled flat springs 52A-52C engaging the carriers 54A-54C by extending the ends 57A, 57B, 57C through one of the slots, e.g., one of the slots 54A2, defined by the carriers 54A-54C. It will be appreciated that such coupling of the coil springs 54A-54C to the respective carriers 54A-54C is provided only by way of illustration, and that the ends 57A-57C of the coiled flat springs 54A-54C may be coupled to the respective carriers 54A-54C in any conventional manner. Moreover, it will be appreciated that the configuration of the carriers 54A-54C is likewise provided only by way of illustration, and that one or more of the carriers 54A-54C may be provided in any conventional form which allow the respective coil spring(s) 52A-52C to be paid out therefrom and to be taken up thereon. In any case, and in any embodiment, it will be understood that the ends 57A-57C of the coil springs 52A-52C need not be coupled directly to the respective carriers 57A-57C, but may instead be coupled to the rear wall 55 or another wall or structure of the housing 50.

Referring now specifically to FIGS. 4A-4C, the housing 50 of the biasing assembly 24 illustratively defines another vertically-extending side wall 50D laterally opposite and spaced apart from the side wall 50E so as to define another channel 59 between the side walls 50D, 50E adjacent to the top end 50A of the housing 50. The ends 56A-56C of the coil springs 52A-52C are fed upwardly from the pocket 50C of the housing 50 and through the channel 59 of the housing 50 toward and into engagement with the housing 40 of the follower assembly 20, as illustrated by example in FIGS. 4A-4C. The width of the channel 59 defined between the opposed surfaces of the walls 50D and 50E is illustratively sized to accommodate the combined thickness of the coil springs 52A-52C. The channel 59 illustratively acts as a guide to guide movement of the coil springs 52A-52C into and out of the pocket 50C of the body 50 of the biasing assembly 24 as the follower assembly 20 is manually moved along the channel 27 of the panel assembly 10.

The ends 56A-56C of the coil springs 52A-52C and the lower portion of the housing 40 of the follower assembly 20 are illustratively configured complementarily to one another such that the ends 56A-56C of the coil springs 52A-52C may be coupled and secured directly to the housing 40 of the follower assembly 20 and so that the coil springs 52A-52C are therefore operatively coupled to and between the housing 50 of the biasing assembly 24 and the housing 40 of the follower assembly 20. In the illustrated embodiment, the end 56A of the coil spring 52A illustratively defines a head portion 58A, and a reduced width neck portion 60A is positioned between the head portion 58A and the remaining body of the coil spring 52A. In the illustrated embodiment, the head portion 58A and the main body of the coil spring 52A have the same widths, and the width of the neck portion 60A is less than the width of both the head portion 58A and the main body of the coil spring 52A. In alternate embodiments, the width of the head portion 58A may be greater or lesser than the width of the main body of the coil spring 52A. In any case, the ends 56B, 56C of the coil springs 52B, 52A are illustratively configured identically to the end 56A of the coil spring 52A as just described.

The side of the housing 40 which faces the inner surface 27A of the side fascia 26B when the follower assembly 24 is received within the channel 27 defined in the panel assembly 10 illustratively defines a spring coupling structure 45 configured to engage and couple to the ends 56A-56C of each of the coil springs 52A-52C. Illustratively, the spring coupling structure 45 is sized and configured to couple to one, two or all three of the coil springs 52A-52C so as to accommodate embodiments which may include fewer than all three of the coil springs 52A-52C. In alternate embodiments, the spring coupling structure 45 may be sized to couple to more than three coil springs so as to accommodate embodiments which may include more than the three illustrated coil springs 52A-52C. It should be noted that the spring coupling structure 45 is defined in the side of the housing 40 which faces the inner side 27A of the side fascia 26B when the follower assembly 24 is received within the channel 27 defined in the panel assembly 10 because that is the same side of the housing 50 which the coil springs 52A-52C enter and exit the biasing assembly 24. In some alternate embodiments, both housings 40, 50 may be configured such that the coil springs 52A-52C enter/exit the housing 40 and attach to the housing 50 on the opposite sides of the housings 40, 50, i.e., on the sides of the housings 40, 50 which face outer side 27B of the side fascia 26B. In other alternate embodiments, the housings 40, 50 may be configured such that one or more biasing springs 52A-52B exit(s) one side of the housing 50 and attaches to the housing 40 on the same respective side while one or more other biasing sprints 52A-52C exit(s) exit(s) the other side of the housing 50 and attaches to the housing 40 that that respective side.

In the illustrated embodiment, the spring coupling structure 45 illustratively includes a channel or pocket 40D, illustratively positioned vertically above the channel or pocket 40E carrying the magnet 44, and a lateral or transverse slot 46 extending into the side of the housing 40 and into the channel or pocket 40D. Adjacent to and just below the slot 46, two vertically-extending walls 48A, 48B are spaced apart laterally or transversely from one another to form a gap or channel 47 therebetween, wherein the gap 47 is open to and in communication with the slot 46. Another wall 49 extends laterally across the side of the housing 40 adjacent to the bottom 40B to define a channel or slot between the wall 49 and the side of the housing 40. Illustratively, the channel or pocket 40D is sized to receive the head portions of the ends 56A-56C of the coil springs 52A-52C therein, the slot 46, the gap 47 and the channel defined between the wall 49 and the side of the housing 40 are all sized to receive therein the combined thickness of the three coil springs 52A-52C, and the gap or channel 47 is further sized to receive the reduced-width neck portions of the ends 56A-56C of the coil springs 52A-52C. Illustratively, the end 56A of the coil spring 52A is coupled and secured to the housing 40 of the follower assembly 20 by passing the end 56A upwardly through the channel defined between the wall 49 and the side of the housing 40, extending the head portion 58A of the end 56A through the slot 46 and into the channel or pocket 40D defined in the housing 40, and then pressing the neck portion 58B into the gap 47 between the side walls 48A, 48B. Illustratively, the bottom wall 40F of the channel or pocket 40D is sloped downwardly, as depicted by example in FIG. 4A, so that the tabs of the head portion 58A defined by, and on either side of, the reduced-width neck portion 58B abut the inner surfaces of the walls 48A, 48B which face the channel or pocket 40D to thereby secure the end 56A to the housing 40 of the follower assembly 20. Illustratively, the end portions 56B, 56C of the coil springs 52B, 52C are then sequentially mounted to the housing 40 in like fashion such that the ends 56A-56C of the coil springs 52A-52B are all secured to the housing 40.

With the ends 56A-56C of the coil springs 52A-52C secured to the housing 40 of the follower assembly 20, the coil springs 52A-52C are operatively coupled to and between the biasing assembly 24, fixed in position within the channel 27 of the panel assembly 10, and the follower assembly 20. As the follower assembly 20 is moved along the channel 27 away from the biasing assembly 24, the biasing springs 52A-52C are paid out of the housing 50 as illustrated by example in FIGS. 1B and 4C during which the biasing springs 52A-52C apply their collective biasing force, i.e., a sum of the biasing forces applied by each of the coil springs 52A-52C, to the follower assembly 20 so as to establish and maintain such collective biasing force between the fixed-position biasing assembly 24 and the follower assembly 20 drawn away therefrom. As the follower assembly 20 is moved along the channel 27 toward the biasing assembly, the biasing springs 52A-52C are drawn back into the housing 50 and re-collected about the respective carriers 54A-54C under the collective bias the biasing springs 52A-52C. As the bottom end 40B of the housing 40 of the follower assembly 20 nears the top end 50A of the housing 50 of the biasing assembly 24, the magnet 44 magnetically couples to the ferromagnetic strip or plate 70, thereby magnetically coupling the follower assembly 20 to the biasing assembly 24 as illustrated by example in FIGS. 1A and 2-4B.

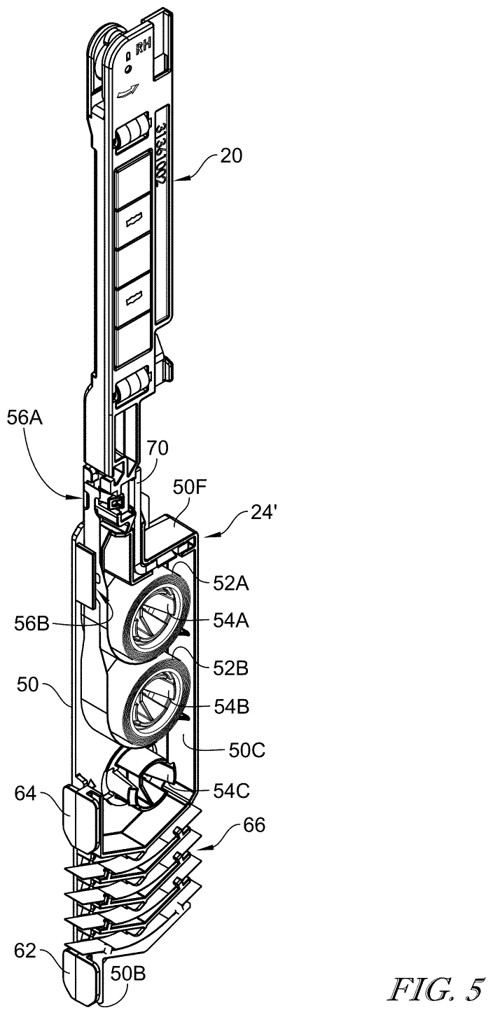

Referring now to FIG. 5, another embodiment is shown of a biasing assembly 24′ configured to be operatively coupled to the follower assembly 20. The biasing assembly 24′ is identical in many respects to the biasing assembly 24 illustrated in FIGS. 1A-4C and described above, and like numbers are therefore used to identify like components. The biasing assembly 24′ differs from the biasing assembly 24 in that the biasing assembly 24′ includes only two coil springs 52A, 52B configured to be coupled to the follower assembly 20 as described above. In the illustrated embodiment, the coil spring 52A is operatively mounted to the carrier 54A and the coil spring 52B is operatively mounted to the carrier 54B as described above. Alternatively, the coil springs 52A, 52B could be mounted to the carriers 54A and 54C or to the carriers 54B, 54C. In other alternate embodiments, the housing 50 may be modified so that it includes only two of the carriers, e.g., the carriers 54A, 54B, spaced vertically apart from one another and suitably positioned within the pocket 50C of the housing 50. Otherwise, the biasing assembly 24′ is structurally and functionally as described above with respect to the biasing assembly 24. The biasing assembly 24′ may be advantageous over the biasing assembly 24 in applications which benefit from the different biasing forces resulting from the use of two rather than three coil springs.

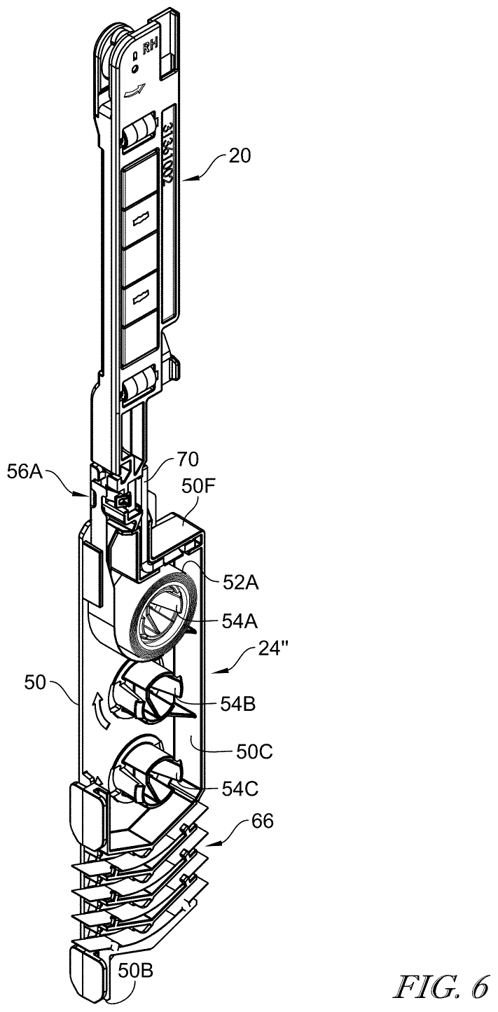

Referring now to FIG. 6, yet another embodiment is shown of a biasing assembly 24″ configured to be operatively coupled to the follower assembly 20. The biasing assembly 24″ is identical in many respects to the biasing assembly 24 illustrated in FIGS. 1A-4C and described above, and like numbers are therefore used to identify like components. The biasing assembly 24″ differs from the biasing assembly 24 in that the biasing assembly 24″ includes only one coil spring 52A configured to be coupled to the follower assembly 20 as described above. In the illustrated embodiment, the coil spring 52A is operatively mounted to the carrier 54A. Alternatively, the coil spring 52A could be mounted to the carrier 54B or to the carrier 54C. In other alternate embodiments, the housing 50 may be modified so that it includes only a single one of the carriers, e.g., the carrier 54A, suitably positioned within the pocket 50C of the housing 50. Otherwise, the biasing assembly 24″ is structurally and functionally as described above with respect to the biasing assembly 24. The biasing assembly 24″ may be advantageous over the biasing assembly 24 and the biasing assembly 24′ in applications which benefit from the different biasing forces resulting from the use of a single coil spring.

In one implementation of any of the foregoing embodiments of the biasing assembly 24, 24′, 24″, the coil one or more spring(s) 52A, 52B and 52C is/are illustratively provided in the form of so-called negative spring(s) (or negative bias spring(s), negative force spring(s) or the like). A negative coil spring differs from a conventional coil spring in that a conventional coil spring typically has a positive bias, i.e., such that the force applied by the spring increases as the elongation distance of the spring increases, whereas a negative coil spring has a negative bias, i.e., such that the force applied by the spring decreases as the elongation distance increases. In the context of the panel assembly 10 illustrated in FIGS. 1A and 1B and described above, a conventional coil springs 52A, 52B and/or 52C will thus apply its/their maximum force to the follower assembly 20 when the blind assembly 16 is fully lowered as depicted by example in FIG. 1B, and will apply its/their minimum force to the follower assembly 20 when the blind assembly 16 is fully raised as depicted by example in FIG. 1A. Such high spring forces applied when the blind assembly 16 is in a fully lowered position could cause the blind assembly 16 to inadvertently lift (also known as upward blind creep), and such low spring forces applied when the blind assembly 16 is fully raised could cause the blind assembly 16 to inadvertently lower (i.e., downward blind creep), and the latter problem is exacerbated as the size and weight of the blind assembly 16 increases. Negative coil spring(s) 52A, 52B and/or 52C, on the other hand, will apply its/their maximum force to the follower assembly 20 when the blind assembly 16 is fully raised, thus preventing, or at least reducing the likelihood of, inadvertent lowering of the blind assembly 16 (i.e., downward blind creep) as such high forces will tend to maintain the follower assembly 20 close to the biasing assembly 24 as depicted by example in FIG. 1A, and will apply its/their minimum force to the follower assembly 20 when the blind assembly is fully lowered, thus preventing, or at least reducing the likelihood of, inadvertent lifting or raising of the blind assembly 16 (i.e., upward blind creep) as such low forces will tend to more easily allow large separations between the follower assembly 20 and the biasing assembly 24 as depicted by example in FIG. 1B. Thus, in one implementation of the panel assembly 10, 10′, 10″, each of the coil springs 52A, 52B, 52C included therein is illustratively a negative spring, i.e., a coil spring having a negative spring bias. In some alternate implementations of the panel assembly 10 or 10′, one of the coil springs 52A, 52B may be a negative spring and the other of the coil springs 52A, 52B may illustratively be a conventional coil spring having a positive bias or may illustratively be a conventional constant-bias coil spring having a constant spring force so as to allow for design flexibility in the magnitude of applied spring force to the follower assembly 20 at one or both of the extreme positions (i.e., lengths) of the spring(s) and/or in the magnitude of applied spring force to the follower assembly 20 in some or all of the range of movement thereof.

In the embodiments illustrated in FIGS. 2-6, the biasing members 52A-52C are illustratively described as being provided in the form of coiled flat springs each having one end 56A, 56B, 56C configured to engage and couple to a lower portion of the housing 40 of the follower assembly 40 and an opposite end 57A, 57B, 57C configured to engage and couple to the housing 50 of the biasing assembly 24, although in alternate embodiments one or more of the biasing members may be provided in other conventional forms, examples of which may include, but are not limited to, non-flat coil springs, conical springs, linear springs, or the like.

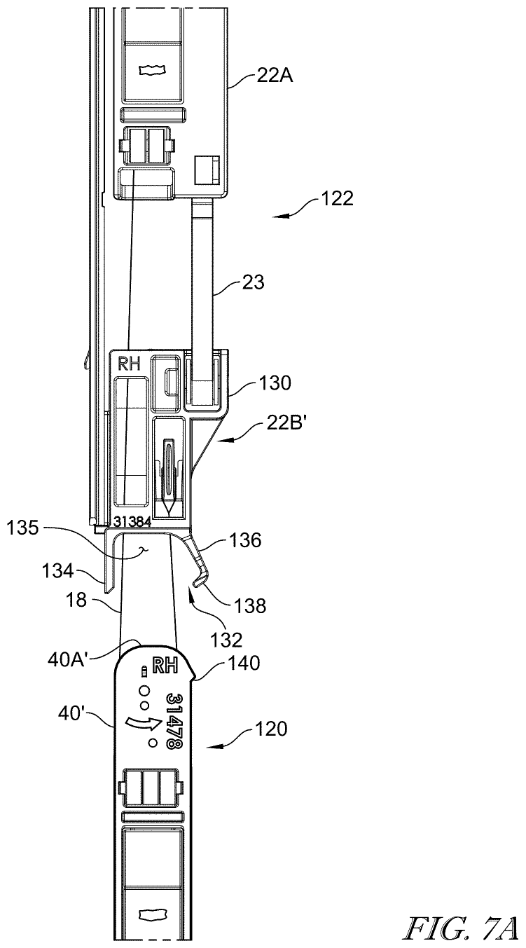

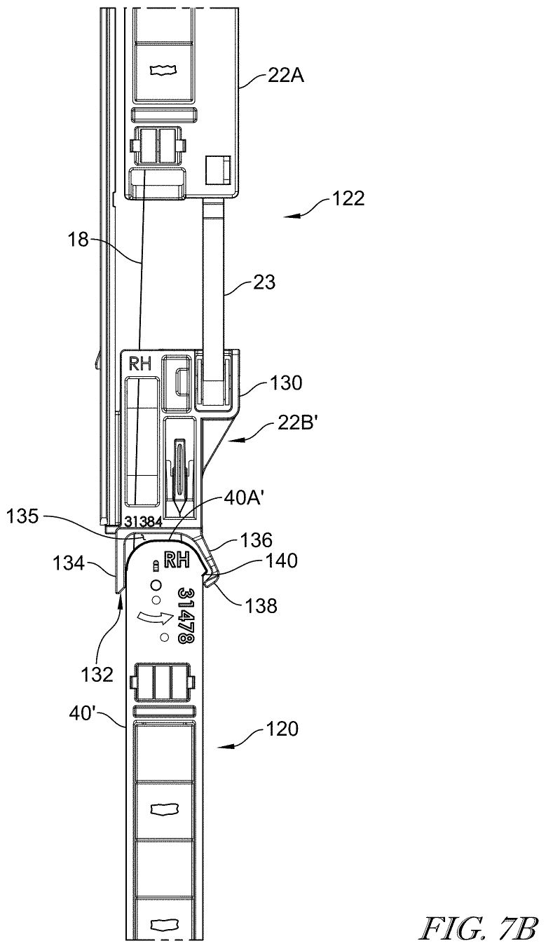

Referring now to FIGS. 7A and 7B, an alternate embodiment 122 of the tilt assembly 22, and an alternate embodiment 120 of the follower assembly 20 are shown. In the illustrated embodiment, the tilt assembly 122 is structurally and operationally the same as the tilt assembly 22 depicted by example in FIGS. 1A and 1B and described briefly above, and differs from the tilt assembly 22 only in the configuration of the intermediate pulley base 22B′. The follower assembly 120 is likewise structurally and operationally the same as the follower assembly 20 depicted by example in FIGS. 1A-6, and differs from the follower assembly 20 only in the configuration of the upper portion of the housing 40′. As described briefly above, the intermediate pulley base 22B′ is fixed in position within the channel 27 defined by and within the side fascia 26B, and the tilt module 22A is movable within the channel 27 relative to the pulley base 22B′ As depicted by example in FIGS. 7A and 7B, the intermediate pulley base 20B″ and the tilt module 22A are operatively coupled to one another by a belt 23 which is also operatively coupled to the upper pulley base 20C (not shown in FIGS. 7A and 7B) such that the tilt module 22A is movable along the channel 27 between the pulley bases 20B and 20C via the belt 23 as is conventional. In the embodiment illustrated in FIGS. 7A and 7B, the cord 18 extends downwardly through the intermediate pulley base 22B′, movaby engages with the follower assembly 120 as described above, and then extends upwardly from the follower assembly 120 and into attachment with a housing 130 of the intermediate pulley base 22B′, although it will be understood that other coupling configurations of the cord 18 are contemplated and intended to fall within the scope of this disclosure. In any case, the follower assembly 120 is thus movable along and relative to the channel 27 between the fixed position intermediate pulley base 22B′ and the fixed position biasing assembly 24.

In the embodiment illustrated in FIGS. 7A and 7B, the lower portion of the housing 130 of the intermediate pulley base 22B′ and the upper portion of the housing 40′ of the follower assembly 120 are configured to be releasably coupled to one another upon movement of the follower assembly 120 proximate to, and in some embodiments into engagement with, the pulley base 22B′ as the blind assembly 16 reaches the fully lowered position depicted by example in FIG. 1B. As the blind assembly 16 is thereafter intentionally raised, e.g., via the operator 36 as described above, the follower assembly 120 and the pulley base 22B′ are configured to decouple from one another as the follower assembly 120 moves away from the intermediate pulley base 22B′.

Illustratively, the bottom portion of the housing 130 of the intermediate pulley base 22B′ defines a latch 132, and the top portion 40A′ of the housing 40′ of the follower assembly 120 defines a catch 140, wherein the latch 132 is configured to releasably capture and engage the catch 140 to releasably couple the pulley base 22B′ and the follower assembly 120 to one another. In alternate embodiments, the top portion 40A′ of the housing 40′ may define the latch and the bottom portion of the housing 130 of the pulley base 22B′ may define the catch. In any case, the latch 132 illustratively include spaced-apart latch arms 134, 136 each extending downwardly away from a respective side of the pulley base housing 130 so as to define a latch pocket 135 between the latch arms 134, 136. In the illustrated embodiment, the latch arm 134 extends in the downward direction approximately parallel with the respective side of the housing 40′ of the follower assembly 120, whereas the latch arm 136 is normally positioned outwardly at an acute angle relative to the respective side of the housing 40′ of the follower assembly 120. An inwardly-facing tongue 138 extends from the free end of the latch arm 136 generally toward the latch arm 134. The latch arm 136 is illustratively flexible or hinged so as to be biased inwardly toward the latch pocket 135.

The upper or top portion 40A′ of the housing 40′ of the follower assembly 120 is illustratively shaped complementarily to the shape of the latch pocket 135, e.g., a rounded rectangular shape, and defines the catch 140 in the form of a projection or tooth along a side of the housing 40′ corresponding to the side of the latch 132 defining the latch arm 136. The latch pocket 135 is illustratively sized slightly smaller than the upper portion 40A′ of the housing 40′ such that the upper portion 40A′ of the housing forces the inwardly biased latch arm 136 outwardly as the upper portion 40A′ of the housing 40′ enters and is received within the latch pocket 135. The inward bias of the latch arm 136 then forces the latch tongue 138 against the outer surface of the housing 40′ as the tooth 140 clears the tongue 138 so as to capture the upper or top portion 40A′ of the housing 40′ in the latch pocket 135 to thereby couple the follower assembly 120 and the pulley base 22B′ to one another as depicted by example in FIG. 7B.

The biasing force of the latch arm 136 is illustratively selected such that the latch 132 will remain engaged with the catch 140 to maintain the pulley base 22B′ coupled to the follower assembly 120 so long as no external force is applied to the follower assembly by the operator 36, and such that the latch 132 will release the catch 140 upon application of normal downward force applied by the operator 36 to the follower assembly 120 to raise the blind assembly 16. The latch 132 and catch 140 thus act together to prevent, or to assist in preventing, upward blind creep when the blind assembly is in, or close to, the fully lowered position depicted by example in FIG. 1B.

It will be understood that the latch and catch embodiment illustrated in FIGS. 7A and 7B and described above are provided only by way of example, and that in alternate embodiments other conventional releasable engagement structures may be used to accomplish the type of releasable coupling between the intermediate pulley base 22B′ and the follower assembly 120 just described. It will be further understood that any such other conventional releasable engagement structure(s) are intended to fall within the scope of this disclosure.

While this disclosure has been illustrated and described in detail in the foregoing drawings and description, the same is to be considered as illustrative and not restrictive in character, it being understood that only illustrative embodiments thereof have been shown and described and that all changes and modifications that come within the spirit of this disclosure are desired to be protected.

What is claimed is:

1. A biasing assembly for facilitating raising and lowering a blind assembly within an insulated glass unit, the biasing assembly comprising:
a housing configured to be fixed in position within the IG unit, and
at least one coil spring carried by the housing, the at least one coil spring having one end coupled to the housing or to a component mounted in the housing and an opposite end configured to operatively couple to a follower assembly for raising and lowering the blind assembly, the at least one coil spring responsive to respective forces applied to the opposite end thereof to pay out of, and be taken up in, the housing.

2. The biasing assembly of claim 1, wherein the housing defines a pocket having at least one spring carrier defined therein,
and wherein the at least one coil spring is operatively mounted to at least one spring carrier within the pocket of the housing.

3. The biasing assembly of claim 2, wherein the at least one coil spring comprises at least one coiled flat spring.

4. The biasing assembly of claim 3, wherein the at least one spring carrier comprises a number of spokes arranged in a concentric pattern,
and wherein the at least one coiled flat spring is mounted on and about the number of spokes of the at least one spring carrier with the one end of the at least one coiled flat spring coupled to at least one of the number of spokes.

5. The biasing assembly of claim 1, wherein the at least one coil spring comprises at least one negative coil spring configured to impart a negative spring bias between the IG unit and the follower assembly.

6. The biasing assembly of claim 5, wherein the at least one coil spring comprises two or more negative coil springs each having one end coupled to the housing or to a component mounted in the housing and an opposite end configured to operatively couple to the follower assembly.

7. The biasing assembly of claim 5, wherein the at least one coil spring further comprises at least one of (a) one or more positive coil springs having one end coupled to the housing or to a component mounted in the housing and an opposite end configured to operatively couple to the follower assembly, the one or more positive coil springs configured to impart a positive spring bias between the IG unit and the follower assembly, and (b) one or more constant-bias coil springs having one end coupled to the housing or to a component mounted in the housing and an opposite end configured to operatively couple to the follower assembly, the one or more constant-bias coil springs configured to impart a constant spring bias between the IG unit and the follower assembly.

8. A blind control assembly for controlling raising and lowering of a blind assembly within an insulated glass (IG) unit, the blind control assembly comprising:
a follower assembly configured to be movable along a channel defined in the IG unit, the follower assembly configured to be coupled via a cord to the blind assembly such that movement of the follower assembly along the channel causes the cord to raise and lower the blind assembly within the IG unit, and
a biasing assembly configured to be fixed in position within the channel defined in the IG unit, the biasing assembly including at least one coil spring having a first end coupled to the biasing assembly and a second end coupled to the follower assembly,
wherein the at least one coil spring is paid out of the biasing assembly by movement of the follower assembly away from the biasing assembly and is taken up in the biasing assembly by movement of the follower assembly toward the biasing assembly.

9. The blind control assembly of claim 8, wherein the biasing assembly comprises a first housing configured to be fixed in position within the channel of the IG unit,
wherein the first housing defines a pocket having at least one spring carrier defined therein,
and wherein the at least one coil spring is operatively mounted to at least one spring carrier within the pocket of the first housing and the first end of the at least one coil spring is coupled to the at least one spring carrier.

10. The blind control assembly of claim 9, wherein the at least one coil spring comprises at least one coiled flat spring.

11. The blind control assembly of claim 8, wherein the at least one coil spring comprises at least one of (a) one or more negative coil springs configured to impart a negative spring bias between the biasing assembly and the follower assembly, (b) one or more positive coil springs having one end coupled to the housing or to a component mounted in the housing and an opposite end configured to operatively couple to the follower assembly, the one or more positive coil springs configured to impart a positive spring bias between the biasing assembly and the follower assembly, and (c) one or more constant-bias coil springs having one end coupled to the housing or to a component mounted in the housing and an opposite end configured to operatively couple to the follower assembly, the one or more constant-bias coil springs configured to impart a constant spring bias between the biasing assembly and the follower assembly.

12. The blind control assembly of claim 9, wherein the follower assembly comprises a second housing movable along the channel of the IG unit,
and wherein the second end of the at least one coil spring and the second housing are configured to be coupled to one another.

13. The blind control assembly of claim 12, wherein the second end of the at least one coil spring comprises a head spaced part from a main body of the at least one coil spring and a neck defined between the head and the main body, the neck having a width less than widths of the head and the main body,
and wherein the second housing defines a second pocket and a second slot through the second housing and into the second pocket, the second slot configured to receive the head of the at least one coil spring therethrough and the second pocket configured to receive the head of the at least one coil spring therein via the second slot and to retain the head therein to couple the second end of the at least one coil spring to the second housing.

14. The blind control assembly of claim 13, wherein the at least one coil spring comprises a plurality of coil springs each having a head spaced part from a main body of the coil spring and a neck positioned between the head and the main body with the neck having a width less than widths of the head and main body,
and wherein the second slot is configured to receive the heads of each of the plurality of coil springs therethrough and the second pocket is configured to receive the heads of each of the plurality of coil springs therein via the second slot and to retain the heads of each of the plurality of coil springs therein to couple the second ends of the plurality of coil springs to the second housing.

15. The blind control assembly of claim 12, further comprising:
one of a magnet and a ferromagnetic component coupled to the first housing, and
the other of a magnet and a ferromagnetic component coupled to the second housing,
wherein the magnet and the ferromagnetic component are positioned on a respective one of the first and second housings to magnetically couple to one another upon movement of the follower assembly proximate to the biasing assembly.

16. The blind control assembly of claim 8, further comprising a tilt assembly including a pulley base fixed in position within the channel such that the follower assembly is movable within the channel between the biasing assembly and the pulley base,
wherein the follower assembly includes a housing having an upper end the pulley base includes a housing having a lower end,
and wherein the lower end of the pulley base housing and the upper end of the follower assembly housing are configured to releasably couple to one another upon movement of the follower assembly proximate to the pulley base.

17. The blind control assembly of claim 16, wherein one of the lower end of the pulley base housing and the upper end of the follower assembly housing defines a latch, and the other of the lower end of the pulley base housing and the upper end of the follower assembly housing defines a catch,
and wherein the latch and the catch are configured to engage one another to couple the follower assembly housing to the pulley base housing.

18. The blind control assembly of claim 17, wherein the catch comprises a projection extending away from a portion of the upper end of the follower assembly housing,
and wherein the latch comprises a latch pocket defined between two latch arms, the latch pocket sized and configured to receive the upper end of the follower assembly therein,
and wherein one of the two latch arms is biased inwardly toward the latch pocket and is configured to engage and capture the projection within the latch as the upper end of the follower assembly housing is received within the latch pocket.

19. An insulated glass unit, comprising:
first and second spaced apart panels,
a spacer affixed to inner surfaces of each of the first and second panels about a periphery of the first and second panels to define an air space bounded by the spacer and the first and second panels,
a blind assembly, including a plurality of blind slats, disposed within the air space,
a flexible cord operatively coupled to the blind assembly for raising and lowering the plurality of blind slats,
a follower assembly coupled via the cord to the blind assembly, the follower assembly movable along a channel defined in the airspace of the IG assembly to raise and lower the blind assembly, and
a biasing assembly fixed in position within the channel, the biasing assembly including at least one coil spring having a first end coupled to the biasing assembly and a second end coupled to the follower assembly,
wherein the at least one coiled spring is paid out of the biasing assembly by movement of the follower assembly along the channel away from the biasing assembly and is taken up in the biasing assembly by movement of the follower assembly along the channel toward the biasing assembly.

20. The IG unit of claim 19, wherein the at least one coil spring comprises at least one coiled flat spring.

21. The IG unit of claim 19, wherein the at least one coil spring comprises at least one of (a) one or more negative coil springs configured to impart a negative spring bias between the biasing assembly and the follower assembly, (b) one or more positive coil springs having one end coupled to the housing or to a component mounted in the housing and an opposite end configured to operatively couple to the follower assembly, the one or more positive coil springs configured to impart a positive spring bias between the biasing assembly and the follower assembly, and (c) one or more constant-bias coil springs having one end coupled to the housing or to a component mounted in the housing and an opposite end configured to operatively couple to the follower assembly, the one or more constant-bias coil springs configured to impart a constant spring bias between the biasing assembly and the follower assembly.

22. The IG unit of claim 19, wherein the biasing assembly comprises a first housing configured to be fixed in position within the channel,
wherein the follower assembly comprises a second housing,
and wherein the at least one coil spring is operatively mounted to the first housing, the first end of the at least one coil spring is coupled to the first housing or to a component mounted to the first housing and the second end of the at least one coil spring is coupled to the second housing.

23. The IG unit of claim 22, further comprising:
one of a magnet and a ferromagnetic component coupled to the first housing, and
the other of a magnet and a ferromagnetic component coupled to the second housing,
wherein the magnet and the ferromagnetic component are positioned on a respective one of the first and second housings to magnetically couple to one another upon movement of the follower assembly proximate to the biasing assembly.

24. The IG unit of claim 19, further comprising a tilt assembly including a pulley base fixed in position within the channel such that the follower assembly is movable within the channel between the biasing assembly and the pulley base,
wherein the follower assembly includes a housing having an upper end the pulley base includes a housing having a lower end,
and wherein the lower end of the pulley base housing and the upper end of the follower assembly housing are configured to releasably couple to one another upon movement of the follower assembly proximate to the pulley base.

25. The blind control assembly of claim 24, wherein one of the lower end of the pulley base housing and the upper end of the follower assembly housing defines a latch, and the other of the lower end of the pulley base housing and the upper end of the follower assembly housing defines a catch,
and wherein the latch and the catch are configured to engage one another to couple the follower assembly housing to the pulley base housing.

26. The blind control assembly of claim 25, wherein the catch comprises a projection extending away from a portion of the upper end of the follower assembly housing,
and wherein the latch comprises a latch pocket defined between two latch arms, the latch pocket sized and configured to receive the upper end of the follower assembly therein,
and wherein one of the two latch arms is biased inwardly toward the latch pocket and is configured to engage and capture the projection within the latch as the upper end of the follower assembly housing is received within the latch pocket.
